(19) United States
(12) Patent Application Publication
(10) Pub. No.: US 2011/0168058 A1
(43) Pub. Date: Jul. 14, 2011

(54) CONSTRUCTION MATERIALS

(75) Inventor: John Paul Forth, Leeds (GB)

(73) Assignee: UNIVERSITY OF LEEDS, Leeds (GB)

(21) Appl. No.: 13/121,146

(22) PCT Filed: Sep. 28, 2009
(86) PCT No.: PCT/GB2009/002292

§ 371 Date: Mar. 25, 2011

(30) Foreign Application Priority Data
Sep. 26, 2008 (GB) 0817677.8

(51) Int. Cl. C04B 16/00

(52) U.S. Cl. 106/504; 106/499

(57) ABSTRACT

A composition for use in the production of a construction element, said composition including an aggregate and a glycerol binder. Construction elements produced using the composition are described. There is further provided a structural element comprising glycerol and an aggregate. A method for producing a construction element is provided including mixing glycerol with an aggregate in the presence of an aqueous medium and then curing said glycerol within said mixture.

### CROSS REFERENCE TO RELATED APPLICATIONS

This application is a national phase application of PCT Application No. PCT/GB2009/002292, filed Sep. 28, 2009, which claims priority to United Kingdom Patent Application No. 0817677.8, filed Sep. 26, 2008, the entire contents of which are both hereby incorporated by reference herein.

### BACKGROUND

The present invention relates to construction materials, methods of producing such materials and methods of construction using such materials.

Recovery of waste cooking oil is strongly supported by the UK Government as it underpins strategies both for reducing dependence on landfill sites for waste disposal and the reduction of fossil fuels for energy. Recovery figures are unclear, however, commonly a major use of waste vegetable oil has been in the production of bio-diesel fuel. Conversion of waste oils and fats to biodiesel fuel has many environmental advantages over petroleum based diesel fuel. However it is not commercially available everywhere and the ‘back-yard’ production of biodiesel may present serious risks as the process uses methanol, a toxic and flammable liquid, and sodium or potassium hydroxide, both of which are caustic. By-product disposal may present further difficulties and environmental considerations may preclude production in sensitive areas. One such by-product is glycerol and related compounds which also require environmentally sound methods for their recovery and, if possible, re-use.

It has become increasingly important to conserve energy and natural resources, and to reduce global pollution and wastage. These global drivers have led the construction industry to consider the use of recycled and waste materials as replacements for traditional aggregates in construction materials, in particular cementitious and clay bound materials. This has helped to improve the sustainability of masonry units which are already considered sustainable. However, the amount of replacement is limited due to the interaction of the replacement materials with the cement/clay binders.

In addition to well-known construction materials, such as bricks, rammed earth is a walling material constructed by compacting layers of earth into a vertical formwork. Compaction is required to achieve an adequate strength for the material, and it also generates a stratified appearance and tactile finish found attractive to many. In using locally available materials and applying minimal processing, the material is considered to have a low embodied energy. It is also readily recyclable, produces minimal waste, and offers good thermal mass that could be used as part of a low energy environmental control strategy. In this way it is considered to be a sustainable building material.

### SUMMARY

An object of the present invention is to providing improved methods for using waste materials in construction methods, including rammed earth construction.

According to a first aspect of the present invention there is provided a composition for use in the production of a construction element, said composition comprising an aggregate and a glycerol-containing binder, wherein the total binder content of the composition is greater than around 10 wt % and less than or equal to around 20 wt %.

A second aspect of the present invention provides a composition for use in the production of a construction element, said composition comprising an aggregate, a vegetable oil and an alkaline activator.

A third aspect of the present invention provides a composition for use in the production of a construction element, said composition comprising an aggregate and an expanded polystyrene binder.

The compositions forming the first, second and third aspects of the present invention may be used to produce any desirable type of construction element. Further aspects of the present invention provide construction elements (e.g. a structural elements) comprising a composition according to the first, second or third aspects of the present invention in which at least partially cured vegetable oil is provided in the composition.

Thus, further aspects of the present invention provide construction elements comprising compositions according to the first and third aspects of the present invention, wherein the compositions additionally comprise vegetable oil and said vegetable oil is at least partially cured. Another aspect provides a construction element comprising a composition according to the second aspect of the present invention, wherein said vegetable oil is at least partially cured.

Aspects of the present invention further provide methods for producing construction elements by mixing the components specified above in the first and third aspects of the present invention and then forming the resulting mixture into said construction element. It can be advantageous to ensure the aggregate is dry before mixing with binder, particularly when components of the binder already contain water, such as when waste glycerol is used, which typically contains up to around 10% water. That being said, if all of the binder components and aggregate are very dry then it may be advantageous to mix them in the presence of an aqueous medium, such as water. Preferably each pair of components (i.e. glycerol and aggregate in the first aspect, and expanded polystyrene and aggregate in the third aspect) is also mixed with vegetable oil at a sufficient temperature to ensure satisfactory mixing of the components and the resulting mixture then heated to at least partially cure the vegetable oil before and/or during the further steps required to form the mixture into the construction element. Such subsequent steps would be well known to the skilled person and would likely include casting.

Preferably during and/or after the various components are mixed the mixture is heated. The or each mixture may be heated to a sufficient temperature to ensure satisfactory mixing of the various components, reduction in viscosity of certain more viscous components (e.g. glycerol), and/or curing of any curable species (e.g. vegetable oil). The mixture may be heated to a temperature of up to around 200° C. and/or not less than around 50° C. More preferably the mixture is heated to a temperature in the range of around 100° C. to around 200° C., more preferably around 80° C. to around 160° C. and most preferably around 120° C. to around 160° C. Heating can be effected over any appropriate time scale depending upon the desired final product and the nature of the components in the initial composition. Partial curing of the vegetable oil is preferably carried out over a time period of up to around 48 hours, more preferably around 24 to 40 hours, and most preferably around 36 hours. It is preferred that said partial curing is carried out over a time period at least around 2 hours, more preferably at least around 6 hours and most preferably at least around 12 hours.

A still further aspect related to the second aspect defined above affords a method for producing a construction element comprising mixing partially cured vegetable oil and an alkaline activator with an aggregate and then further curing said vegetable oil within said mixture. The further curing step may be carried out employing any of the temperatures and/or time periods specified above in relation to heating of the mixtures.

It is preferred that said construction element is a structural element. A further aspect of the present invention related to the above defined first aspect provides a structural element comprising an aggregate, glycerol and at least partially cured vegetable oil. Another aspect related to second aspect defined above provides a structural element comprising an aggregate, an alkaline activator and at least partially cured vegetable oil. In a still further aspect, this time related to the third aspect of the present invention, a structural element is provided which comprises an aggregate, expanded polystrene and at least partially cured vegetable oil.

Moreover, it is preferred that said construction element comprises internal or external reinforcement. Said internal reinforcement preferably comprises or consists of a fibrous reinforcing agent. The term ‘fibrous’ is used herein to denote an entity which is generally elongate in shape, and is intended to encompass rod-like entities that are solid along their length, or entities which are partly or completely hollow along the full extent of their length so as to define tubular or partly tubular structures. The construction element may contain up to around 100 kg/m³ of the fibrous reinforcing agent, more preferably around 25 to 75 kg/m³ of the fibrous reinforcing agent and most preferably around 50 kg/m³ of the fibrous reinforcing agent. The fibrous reinforcing agent may comprise fibres possessing a cross sectional diameter of up to around 10 mm, more preferably up to around 5 mm, and most preferably around 1 mm. Moreover, the fibrous reinforcing agent may comprise fibres possessing any appropriate length. The length of the fibres may be up to around 200 mm or up to around 100 mm. It is preferred that the fibres are at least about 5 to 10 mm long. It is particularly preferred that the fibres are around 25 to 75 mm long, more preferably around 50 mm long. While any desirable type of fibre may be used, steel fibres have been found to be particularly suitable, for example, NOVOCON HE1050 fibres (Propex Concrete Systems Corp.).

A construction element is considered to be any element which can be used in construction applications and therefore encompasses both structural (i.e. load bearing) elements (e.g. beams, columns, walls, slabs, paving etc) and non-structural (i.e. essentially non-load bearing) elements (e.g. building blocks, masonry units, building stones, bricks and the like). It will be appreciated that non-structural elements, although varying in size, are designed primarily to be small enough to be handled by a single worker, whereas structural elements are generally larger and designed to act as load bearing members, often in combination with at least one further structural element.

Accordingly, it is preferred that compositions according to the first, second and/or third aspects of the present invention is/are used to manufacture construction elements. It is further preferred that these compositions are used to manufacture structural elements. Examples of structural applications which could employ structural elements manufactured from these composition include rammed earth construction, hollow section steel column infill, stabilised beams and slabs (flat, ribbed, etc), collar jointed masonry (crumb rubber in-fill) to resist blast loading/act as a retrofitting method for seismic areas etc.

It will be appreciated that due to the size, shape and method of construction of smaller non-load bearing construction elements of the kind described in PCT/US01/10537, such elements will predominantly fail under load in either simple compression or simple flexure (tensile stresses). Hence the design requirements for element such as these are very basic regardless of the end application (typically walls). As long as the elements satisfy a pre-determined compressive or flexural strength level for a certain application (e.g. wall), and as long as they can be bonded with mortar, they are deemed suitable for that application or load level (e.g. height of wall).

The composition of the first and/or second aspects of the present invention are eminently suitable to be used to form cladding panels, up to, for example 2 to 3 meters wide by 30 meters high (off-the-frame cladding).

While the composition of the first three aspects of the present invention can be used to form non-structural element such as individual building blocks/bricks, it is envisaged that the composition is particularly preferred as an alternative to concrete, steel or wood load bearing beams, columns, walls, slabs and the like.

Structural members are not designed to act individually, rather they are built into a structural system whereby many members have to interact directly with each other. For example, in a typical structure when a slab is loaded, the bending & shear stresses are transferred from the slab to the supporting beams which in turn transfer the stresses to the supporting columns which in turn transfer the stresses on to the foundations. In contrast, building blocks of the kind contemplated in PCT/US01/10537 are simply inactive low cost void fillers between the stress dissipating mortar joints.

It will be further appreciated that the behaviour of the structural elements (in terms of performance under applied loads and stresses and strains) is very different to that of non-structural elements. For example, compare the complexity of stresses in a long span beam with those of a block under simple compression.

The design requirements of structural elements (i.e. analysis of distribution of bending moments, shear stresses in addition to tensile stresses and compressive stresses) in order to determine the dimensional requirements of the elements are far more sophisticated (and typically require the expertise of a Structural and/or Civil engineer) than those of more simple non-structural elements.

In addition to the above methods of reinforcement, it will be appreciated that the construction elements formed from the first, second and/or third aspects of the present invention may be internally or externally reinforced with steel/carbon/glass reinforcing bars, strips or bonded thin plates, fibre reinforced, pre-tensioned, post-tensioned, and the like.

The performance and failure mechanism of such a reinforced element would be entirely different from a non-reinforced element. The performance and failure mechanism of construction elements which incorporate reinforcing elements are based on dimensions, reinforcement type, reinforcement cross sectional contribution to the element, reinforcement details, curing condition, and interconnection with other structural elements in addition to simply its material composition.

In some cases, a structural element may form an integral part of another structural element, e.g. as a substitute to concrete infill in hollow section steel columns in high rise construction.

Structural elements which may be provided by way of the various above defined aspects of the present invention include monolithic stress dissipating structures, civil engineering structures, structural monolithic members, and structural members. Examples of possible structural applications include rammed earth construction, hollow section steel column infill, and beams and slabs (flat, ribbed, etc). The current mixing and compaction techniques for producing the rammed earth will remain the same, except for the addition of the vegetable oil(s). As a result it is envisaged that some if not all of the weaknesses noted in relation to conventional rammed earth construction will be mitigated by the inclusion of the vegetable oil(s).

The aggregate employed in each of the above-defined aspects of the present invention is preferably graded. The graded aggregate may have a maximum aggregate particle size of around 15 mm, more preferably around 13 mm and still more preferably around 10 mm.

A graded aggregate having any desired porosity may be used, but preferably the graded aggregate possesses a porosity of greater than around 5 and/or less than around 50%. Preferably the graded aggregate has an aggregate porosity in the range of around 10% to around 40%, more preferably in the range of around 20% to around 30%.

Any suitable type of glycerol can be employed in the various aspects and preferred embodiments of the present invention. Moreover, more than one type of glycerol may be used in any particular composition. To address environmental concerns surrounding waste glycerol, it is preferred that the glycerol in the compositions according to the present invention is derived from waste glycerol, or that the total glycerol content of any particular composition according to the present invention contains some glycerol derived from waste glycerol in combination with virgin glycerol. Of course, it further preferred embodiments, the total glycerol content may be made up of virgin glycerol.

Preferably the total glycerol content of compositions according to the first aspect of the present invention, and embodiments of the second and/or third aspects of the present invention which optionally contain some glycerol, is about 1 to about 20 wt %. It is more preferred that the total glycerol content of these compositions is about 5 to 20 wt %, more preferably about 7 to 18 wt % and yet more preferably around 10 to 15 wt %. At present glycerol, particularly waste glycerol (typically 90:10 glycerol:water) is of relatively low cost compared to other binder materials, such as waste and virgin vegetable oils. While this is the case relatively high levels of glycerol are preferred from an economic perspective. Previous work to develop compositions suitable to be formed into construction elements containing vegetable oil or glycerol containing binders typically contained relatively low levels of such binders, such as around 1 to 5 wt %. Moreover, it is notable that previous work avoided or minimised the use of glycerol in spite of its relatively low cost, presumably because previous workers did not recognise the potential of glycerol as a low cost binder or were unable to produce compositions containing higher levels of glycerol which could be formed into satisfactory construction elements. As exemplified below, the present inventors have both identified the potential of glycerol as a potential binder and developed a wide range of compositions that have been formed into construction elements that meet or exceed current construction requirements.

Notwithstanding the above, it is recognised that in some instances, for example where costs constraints are not as important or when glycerol ceases to be relatively cheap, it may be desirable to use lower levels of glycerol, such as around 2 to 15 wt %, around 3 to 10 wt %, or around 5 to 10 wt %. In preferred embodiments of such compositions the total glycerol content in the compositions is in the range of about 4 to 5 wt %, or still more preferably about 5 wt %. The examples below demonstrate how such lower levels of glycerol can also be used.

In each aspect and preferred embodiment of the present invention employing glycerol, it is preferred that such glycerol containing compositions, construction elements and structural elements further comprise an alkaline activator. One reason for including such an activator is to initiate oxidation of the glycerol present in the compositions to improve its ability to bind the aggregate. The inventors do not wish to be bound by any particular theory but it is believed that glycerol's ability to bind aggregate when in the green state (i.e. virgin or non-cured state) results from glycerol's inherently high viscosity and that oxidation, possibly aided by the presence of an alkaline activator, may improve glycerol's ability to function in this way. Moreover, when glycerol is employed in combination with vegetable oil in preferred embodiments of the present invention, these two components may react with one another, particularly upon heating, to generate a further substance which can function as an improved aggregate binder.

Any suitable alkaline activator as would be well known to the skilled person can be used, although it is preferred that said activator comprises alkaline earth metal ions, e.g. calcium or magnesium ions. Moreover, the alkaline activator may comprise halide ions, such as chloride ions. In particularly preferred embodiments of compositions according to the first three aspects of the present invention which incorporate glycerol, the compositions contain calcium chloride as an activator. Each composition can contain one or more different types of activator in any particular amount. It is preferred that each composition contains up to around 10 wt % of said alkaline activator, and/or that each composition contains at least around 0.1 wt % of said alkaline activator. In further preferred embodiments, the alkaline activator is provided in amounts of around 1 to around 8 wt %, and more preferably around 2 to around 5 wt %.

It is preferred that the total expanded polystyrene content of compositions according to the third aspect of the present invention is about 1 to about 40 wt %. It is more preferred that the total expanded polystyrene content of these compositions is about 1 to about 20 wt %, more preferably about 2 to about 15 wt %, still more preferably about 3 to about 10 wt % or about 5 to about 10 wt %. In a preferred embodiment the total expanded polystyrene content in the compositions is in the range of about 4 to about 5 wt %, or still more preferably about 5 wt %.

As described above, while the second aspect of the present invention comprises vegetable oil, vegetable oil is also provided in preferred compositions according to the first and third aspects of the present invention. In each case, it is preferred that each composition comprises at least one vegetable oil and the or each vegetable oil is separately selected from the group consisting of vegetable oil originating from any plant source, boiled vegetable oil, polymerised vegetable oil, heat treated vegetable oil, fully or partially oxidised vegetable oil, waste vegetable oil and recycled vegetable oil.

Particularly preferred compositions according to the present invention employ a binder comprising glycerol and vegetable oil, which may, for example be mixed or blended together before being added to the aggregate or combined with the aggregate separately. In a preferred embodiment, the vegetable oil content of the composition according to the present invention is about 1 to about 15 wt vegetable oil, more preferably about 5 to about 10 wt %. At present, vegetable oil is more costly than glycerol and so for economic reasons it is preferred to minimise as far as possible the amount of vegetable oil present in the composition, while ensuring that the total binder content (made up of glycerol and optionally one or more other binders) is adequately high, i.e. above around 10 wt %, so that the final construction element exhibits acceptable performance.

A composition according to a first preferred embodiment of the present invention has a glycerol content of around 12 to 17 wt % and additionally comprises around 3 to 8 wt % vegetable oil.

A second preferred composition has a glycerol content of around 13 wt % and a vegetable oil content of around 4 wt %.

It will be appreciated that the amount of glycerol, vegetable oil and any other component of the aggregate binder should be selected to ensure that the total binder content of the composition exceeds around 10 wt % while not exceeding around 20 wt % so that the resulting construction elements performs to acceptable standards. As exemplified below with a glycerol-only binder (i.e. a binder containing just glycerol and no other binder material, e.g. vegetable oil), when the total binder content of the composition exceeds 20 wt % the composition containing the binder and the aggregate cannot be compacted at sufficiently high pressures to produce acceptable construction materials.

The total binder content should be determined to suit a particular application of the resulting construction element. It is generally acknowledged that higher compaction levels are required to produce stronger construction materials. While the inventors do not wish to be bound by any particular theory, it has been observed that a relationship appears to exist between binder content and the level of compaction which can be satisfactorily applied to the binder/aggreagate mixture. Essentially, if stronger construction elements are needed then higher compaction levels are required in which case compositions should be chosen which contain amounts of binder which are below the 20 wt % maximum. This being the case it has been determined that in preferred compositions the total binder content of the composition is around 12 to 18 wt %, more preferably around 15 to 18 wt %.

Preferably the compositions according to the first, second and/or third aspects of the present invention comprise at least one type of aggregate and the or each aggregate is separately selected from the group consisting of natural soil, quarried crushed mineral aggregates from igneous, metamorphic or sedimentary rocks, including unused and waste aggregates from quarry operations, natural sand, crushed sand, gravel, dredged aggregates, china clay sand, china clay stent, china clay wastes, natural stone, recycled bituminous pavements, recycled concrete pavements, reclaimed road base and subbase materials, recycyled automotive components, such as brake disc linings, crushed concrete, crushed bricks, construction and demolition wastes, waste/recycled flue gas ashes, crushed glass, slate waste, waste plastics, incinerated animal bones, egg shells, sea shells, and by-products from incinerators.

The compositions according to the first, second and/or third aspects of the present invention additionally may comprise at least one further component selected from the group consisting of a cementitious binder, a pozzolanic binder, an inert filler, an active filler, a bituminous binder, a natural polymer, a synthetic polymer, and a metal catalyst.

The construction elements incorporating the compositions of the first, second and/or third aspects of the present invention and the associated structural elements are produced by mixing the various non-aggregate components, e.g. vegetable oil, glycerol, expanded polystyrene and/or alkaline activator, with aggregates which are provided in an amount of up to around 80 to 90 wt%. An amount (preferably a minor amount) of additives may also be added at this stage of the mixing process. Mixing can be achieved using manual, mechanical mixers or high shear mixers with the constituents at ambient or elevated temperatures in an open mixer or in a sealed reaction vessel.

Compaction of the mixture can be achieved by hand-held pneumatic rammers as is the norm for example, for rammed earth construction.

Curing and its effects on the performance of the construction elements have been extensively investigated. A method of pre-oxidising the oil(s) prior to preparing the loose mix has been developed, which involves bubbling air though the oil(s) to initiate hardening which will subsequently reduce curing times of the mixture and curing temperatures. Pre-oxidation may also be achieved using appropriate microwave radiation. It will be appreciated that the degree of pre-oxidation required to optimise curing but still allow initial mixing of the aggregates and the oil(s) is a critical balancing process.

Depending on the type(s) of vegetable oil used and the final strength of the construction element required, the compacted sections require some form of curing for the oil(s) to polymerise and thus act as a hardened binder imparting strength to the construction element. Curing may be achieved by the application of microwave radiation and/or heat. Heat curing may be achieved following formwork removal via external means by covering the wall unit with a heated jacket/blanket. Heat curing may also be achieved internally whilst the formwork is still on the units by inserting/incorporating heating elements (e.g. heated pipes) into the construction units. It will be appreciated that the heating elements may be suitably arranged to provide reinforcement to the construction element and thereby act as both a heating/curing element and rebar.

In any of the above-defined methods according to different aspects of the present invention, the vegetable oil may be partially cured by any convenient means prior to mixing with the other components present in the aggregate-containing mixture. In preferred embodiments of the methods according to the present invention the or each method further comprises partially curing the vegetable oil prior to mixing said partially cured vegetable oil with the other components. The temperature and duration of heat curing required are dependent at least in part on the type of vegetable oil(s) used. Temperatures ranging from ambient to 250° C., preferably in the range 160 to 200° C. are suitable. Trials have also shown that adequate curing can be achieved by holding the ideal curing temperature for durations up to 4 days, preferably in the range 0.5 to 3 days depending on the mix composition and temperature of curing. Partial curing of the vegetable oil may be carried out at a temperature of up to around 200° C. and/or not less than around 50° C. More preferably partial curing is effected at a temperature in the range of around 100° C. to around 200° C., more preferably around 120° C. to around 180° C. and most preferably at a temperature of around 160° C. Partial curing of the vegetable oil is preferably carried out over a time period of up to around 48 hours, more preferably around 24 to 40 hours, and most preferably around 36 hours. It is preferred that said partial curing is carried out over a time period at least around 2 hours, more preferably at least around 6 hours and most preferably at least around 12 hours.

In a preferred embodiment the vegetable oil is partially cured by bubbling air though the oil to initiate oxidation and curing in advance of mixing the oil with the aggregate. Curing may be achieved by the application of microwave radiation, with or without additional curing by other means, such as heating.

Mixing of the partially cured vegetable oil and the aggregate-containing mixture may be carried out at any appropriate temperature to ensure satisfactory mixing, while mixing is preferably carried out at around ambient or room temperature, e.g. around 20 to 25° C., it may be necessary to heat the different components prior to mixing and/or to heat the mixture during mixing to a temperature above ambient or room temperature to ensure satisfactory mixing. A temperature of at least around 30 to 40° C. or higher may be required, for example to ensure the vegetable oil is sufficiently miscible with any glycerol present in the mixture. Preferably mixing of the partially cured vegetable oil and the aggregate is carried out over any desirable time period but it is preferred that a time period of up to around 5 minutes, more preferably up to around 2 minutes is employed. It is particularly preferred that mixing is carried out over a time period of around 1 to 2 minutes.

The level of compaction of the aggregate-containing mixtures may influence many different properties of the final construction element formed. For example, it has been determined that the compressive strength of a cured construction element is directly proportional to the compaction effort applied (stress level) to the loose mixture in the compaction moulds. While any appropriate compaction level can be employed to suit a particular application it has been determined that a particularly preferred range of compaction levels lie in the range of around 1 to 20 MPa depending upon the desired strength of the final construction elements. Preferred minimum compaction levels are around 1, 2 or 4 MPa, while preferred maximum compaction levels are around 16, 12 or 8 MPa. As such, preferred compaction levels are around 2 to 16 MPa or around 4 to around 12 MPa. Particularly suitable compaction levels to produce acceptable construction elements containing around 15 to 18 wt % of a glycerol-containing binder are around 2 to 8 MPa, most preferably around 4 MPa.

The extent of curing throughout the construction element need not be uniform. The curing regimes forming preferred embodiments of the present invention can be selected to provide adequate stability and performance for the intended application. This non-uniformity in oxidised material depends on the size of the construction element and its porosity, however it is to be noted that the vegetable oil in any block over 35 mm thick which has been cured typically at around 200° C. for 12 to 24 hours will not be completely oxidised. The larger the element the more influence the level of curing will have on its performance. To control this influence the mixture and/or construction element can be designed to include perforations/through voids having desired characteristics.

The relatively large size of typical structural elements (such as load bearing beams) dictates that the elements are preferably cured at least partially in-situ using especially developed curing systems (e.g. in-built curing elements, external heating jackets, etc.). These heating systems in many cases will from part of the structural element, e.g. the internal heating elements in a slab or beam can be in tubular form and can act as reinforcement and/or ducts once the structural element is ready for service. Or in the case of pre-cast elements, specially designed curing systems can be developed to cater for the scale/size of curing.

In conventional methods for producing construction elements involving curing, and those described in PCT/US01/10537, the element is deemed ready for use as soon as the curing regime is complete. However, the present invention can employ staged curing such that the construction element gains strength/stiffness as time and curing progress. The design of the structural members may incorporate curing time as an element of design. For example, while a long span reinforced beam is being constructed in stages, parts of the beam may be allowed to cure at a faster rate than others to fit in with the timescale of stress transfer, i.e. when certain parts of the span are to be loaded as opposed to others.

The dimensions and sophistication of the construction elements allow different parts of the elements to be cured to different extents, different rates and at different time scales. For example, using the concept that materials are generally weaker in tension than compression, the underside of a structural beam in accordance with one or more aspects of the present invention (which acts primarily in tension) can be allowed to cure first, thus enabling the beam to sustain some load prior to curing the upper parts (which act primarily in compression). Staged curing of this kind can also assist the transfer of stress between the material of the construction element (i.e. the vegetable oil/aggregate/optional additive mixture) and any reinforcement that is present, which will promote the composite behaviour required in this region of the elements at that time. Another example is where imbedded curing elements are incorporated into the construction element design, in which case the core of the element acquires the required strength earlier than the outer parts, i.e. curing from inside out. This of course has to be carefully factored in as part of the design phase, and cannot be allowed to develop in an uncontrolled manner.

In the above defined aspects of the present invention preferred types of vegetable oils that may be used singly or in any desirable combination (for example, mixed or blended together) include vegetable oil originating from any plant source (e.g. rapeseed, palm, linseed, olive, canola, sunflower, soybean, cotton, peanut, maize, coconut, corn), boiled vegetable oil, polymerised vegetable oil, heat treated vegetable oil, and fully or partially oxidised vegetable oil. At least one type of waste vegetable oil (e.g. from cooking) and/or at least one type of recycled vegetable oil may be used either on its own or in combination with any of the above-mentioned vegetable oils.

Each of the above mentioned vegetable oils may be used individually or in combination (e.g. blended) with one or more of the following additives. Preferred types of additive that may be used include cementitious binders (e.g. ordinary Portland cement, sulphate resisting cement, high alumina cement, gypsum, cement kiln dust, etc.), pozzolanic binders, (pulverised fuel ash, glass granulated blast furnace slag, silica fume, steel slag, rice husk ash, montmorillonite, kaolinite, illite, etc.), inert fillers (crushed and powdered material from any igneous, metamorphic or sedimentary rocks, carbon blacks), active fillers (lime, hydrated lime, crumb rubber, etc.), bituminous binders (straight run bitumens, oxidised bitumens, hard grade bitumens, bituminous emulsions, cutback bitumens, polymer modified bitumens, foamed bitumens, etc.), natural polymers (plant derived resins, rubber/latex), synthetic polymers (epoxy, rubber, etc.), and/or metal catalysts (metal salts “oxides, hydroxides, sulfates & chlorides” including those of; zinc, nickel, zirconium, aluminium, titanium, copper, iron, calcium, etc.). If used, the amount of catalyst added depends to some extent on the medium used to prepare the catalyst (e.g. an acid) and on the type of oil. It is within the purview of the skilled person to determine the amount of catalyst required.

Blending can be carried out at ambient and/or elevated temperatures, using slow or high shear mixers in open mixers or closed reaction vessels.

The following aggregates may form part of the raw materials included in the mixtures in accordance with the above defined aspects of the present invention. Preferred aggregates include any individual or combination of the following materials: natural soil; quarried crushed mineral aggregates from igneous, metamorphic or sedimentary rocks, including unused and waste aggregates from quarry operations (e.g. fines); natural sand; crushed sand; gravel; dredged aggregates; china clay sand; china clay stent; china clay wastes; natural stone; recycled bituminous pavements; recycled concrete pavements; reclaimed road base and subbase materials; crushed concrete; crushed bricks; construction and demolition wastes; waste/recycled flue gas ashes from, for example, asphalt plants; crushed glass; slate waste; waste plastics; incinerated animal bones; egg shells; sea shells; and waste aggregates as by-products from incinerators (for example incinerator coal fly ash, incinerator coal bottom ash, incinerated sewage sludge, Municipal incinerator bottom and fly ash, steel slag coarse and fine aggregates, blast furnace slag, GGBS, tin slag, copper slag, cement kiln dust, and the like).

Vegetable oils, glycerols and their derivatives, like all organic matter are biodegradable materials. The construction elements made with these mateirals are therefore likely to be susceptible to microbial attack. This may not be of fundamental importance when the product is a non-structural element, such as a simple building block, but it would be an issue if the product is a structural member, such as a beam. Hence structural element durability may advantageously include biodegradability at the design stage in addition to in-service performance under load. In some cases, the structural element may require an external protective coating to guarantee durability, which may, for example, be in the form of cementitious rendering, polymeric coating, or the like.

The invention will be further described by way of example only with reference to the following Comparative Example.

### BRIEF DESCRIPTION OF THE DRAWINGS

FIG. 1 is a graph illustrating the grading of aggregate used in the following Examples;

FIG. 2 is a graph of strength against compaction pressure for a series of samples according to the present invention incorporating 14 wt % waste glycerol binder (equivalent to a binder containing 12.6 wt % pure glycerol);

FIG. 3 is a graph of strength against compaction pressure for two series of samples according to the present invention incorporating binders comprising a waste glycerol/vegetable oil blend—first series: 15 wt % waste glycerol/5 wt % vegetable oil (equivalent to 13.5 wt % pure glycerol/5 wt % veg. oil); second series: 10 wt % waste glycerol/3.3 wt % vegetable oil (equivalent to 9 wt % pure glycerol/3.3 wt % veg. oil);

FIG. 4 is a graph of strength against compaction pressure for a series of samples according to the present invention incorporating 22 wt % waste glycerol binder (equivalent to a binder containing 19.8 wt % pure glycerol);

FIG. 5 is a graph of strength against waste glycerol content for a series of samples according to the present invention incorporating 16 to 24 wt % waste glycerol binder (equivalent to 14.4 to 21.6 wt % pure glycerol);

FIG. 6 is a graph of creep against time for three samples according to the present invention incorporating a waste glycerol/vegetable oil binder comprising 15 wt % waste glycerol/5 wt % vegetable oil (equivalent to 13.5 wt % pure glycerol/5 wt % veg. oil);

FIG. 7 is a graph of shrinkage against time for the same three samples as used to produce the results shown in FIG. 6;

FIG. 8 is a graph of creep against time for three samples according to the present invention incorporating a waste glycerol/vegetable oil binder comprising 15 wt % waste glycerol/5 wt % vegetable oil (equivalent to 13.5 wt % pure glycerol/5 wt % veg. oil);

FIG. 9 is a graph of shrinkage against time for the same three samples as used to produce the results shown in FIG. 8; and

FIG. 10 is a graph showing the compressive strength of five sample blocks produced using different compositions; the first sample (12% oil, 0% activator, 0% glycerol) is not in accordance with any aspect of the present invention and is presented for comparison; the remaining four samples are in accordance with various aspects of the present invention.

### DETAILED DESCRIPTION

### EXAMPLES

A large number of tests have been carried out to investigate glycerol-containing compositions for use in the production of construction elements. In the tests described below the source of the glycerol was waste glycerol containing 90 wt % glycerol and 10 wt % water, and the aggregate that was used had the composition shown below in Table 1 and FIG. 1.

TABLE 1

| | |
|---|---|
| Sieve size (mm) | Percentage by mass passing (%) |

IBA 5-10 mm

| | |
|---|---|
| 10 | 100.00 |
| 8 | 72.00 |
| 6.3 | 34.06 |
| 5 | 0.00 |

IBA <5 mm

| | |
|---|---|
| 5 | 100.00 |
| 3.35 | 76.87 |
| 2.36 | 59.28 |
| 1.18 | 26.22 |
| 0.6 | 0.00 |

A total of 73 samples were prepared and tested for their performance as construction elements. The composition of the samples and the results obtained are set out below in Tables 2 to 5. In the tables, WG=waste glycerol; G=glycerol and WCO=waste cooking (vegetable) oil.

TABLE 2

| | Material Composition (wt %) | | | | | | | | | | Curing | Curing | Comp | | |
|---|---|---|---|---|---|---|---|---|---|---|---|---|---|---|---|
| | | Fine | | | | | Dimension (mm) | | | Weight | Temp. | Time | Pres. | Strength | Density |
| No | IBA | IBA | WG | G | Water | WCO | L | W | H | (g) | (° C.) | (h) | (MPa) | (MPa) | (g/cm³) |
| 1 | 100 | 0 | 16 | 14.4 | 0 | 0 | 100 | 100 | 56.77 | 890 | 160 | 24 | 4 | 5.7 | 1.608 |
| 2 | 100 | 0 | 18 | 16.2 | 0 | 0 | 100 | 100 | 56.76 | 878.5 | 160 | 24 | 4 | 6.1 | 1.587 |
| 3 | 100 | 0 | 20 | 18 | 0 | 0 | 100 | 100 | 55.04 | 875.5 | 160 | 24 | 4 | 7.6 | 1.631 |
| 4 | 100 | 0 | 22 | 19.8 | 0 | 0 | 100 | 100 | 53.8 | 864 | 160 | 24 | 4 | 7.9 | 1.647 |
| 6 | 100 | 0 | 24 | 21.6 | 0 | 0 | 100 | 100 | 54.71 | 851 | 160 | 24 | 4 | 3.2 | 1.595 |
| 9 | 100 | 0 | 22 | 19.8 | 0 | 0 | 100 | 100 | 55.2 | 882 | 160 | 24 | 8 | 4.9 | 1.639 |
| 10 | 100 | 0 | 22 | 19.8 | 0 | 0 | 100 | 100 | 50.58 | 799 | 160 | 24 | 4 | | 1.62 |
| 11 | 100 | 0 | 22 | 19.8 | 0 | 0 | 100 | 100 | 50.66 | 799 | 160 | 24 | 4 | | 1.618 |
| 12 | 100 | 0 | 20 | 18 | 0 | 0 | 100 | 100 | 55.13 | 868 | 160 | 24 | 4 | 7.95 | 1.615 |
| 13 | 100 | 0 | 22 | 19.8 | 0 | 0 | 100 | 100 | 57.81 | 858 | 160 | 24 | 1 | 3.8 | 1.522 |
| 14 | 100 | 0 | 22 | 19.8 | 0 | 0 | 100 | 100 | 55.76 | 858 | 160 | 24 | 2 | 5.3 | 1.578 |
| 15 | 100 | 0 | 22 | 19.8 | 0 | 0 | 100 | 100 | 53.29 | 862 | 160 | 24 | 8 | 8.05 | 1.659 |
| 16 | 100 | 0 | 22 | 19.8 | 0 | 0 | 100 | 100 | 55.06 | 887 | 160 | 12 | 4 | 3.5 | 1.652 |
| 17 | 100 | 0 | 22 | 19.8 | 0 | 0 | 100 | 100 | 55.22 | 865 | 160 | 48 | 4 | 4.9 | 1.607 |
| 18 | 100 | 0 | 22 | 19.8 | 0 | 0 | 100 | 100 | 55.31 | 856 | 160 | 96 | 4 | 3.9 | 1.587 |
| 19 | 100 | 0 | 20 | 18 | 0 | 0 | 100 | 100 | 54.02 | 896 | 160 | 12 | 4 | 4.6 | 1.701 |
| 20 | 100 | 0 | 20 | 18 | 0 | 0 | 100 | 100 | 54.86 | 870 | 160 | 48 | 4 | 6.15 | 1.627 |
| 21 | 100 | 0 | 20 | 18 | 0 | 0 | 100 | 100 | 55.25 | 863 | 160 | 96 | 4 | 7.2 | 1.602 |
| 23 | 80 | 20 | 20 | 18 | 0 | 0 | 100 | 100 | 52.27 | 876.5 | 160 | 24 | 4 | 11.5 | 1.72 |
| 24 | 80 | 20 | 20 | 18 | 0 | 0 | 100 | 100 | 52.15 | 884 | 160 | 48 | 4 | 11.35 | 1.739 |
| 25 | 80 | 20 | 20 | 18 | 0 | 0 | 100 | 100 | 52.26 | 866 | 160 | 72 | 4 | 10.65 | 1.7 |
| 26 | 80 | 20 | 20 | 18 | 0 | 0 | 100 | 100 | 52.1 | 862 | 160 | 96 | 4 | 10.7 | 1.697 |
| 27 | 100 | 0 | 18 | 16.2 | 0 | 0 | 100 | 100 | 54.83 | 890 | 160 | 24 | 4 | 8 | 1.665 |

TABLE 3

| | Material Composition (wt %) | | | | | | | | | | Curing | Curing | Comp | | |
|---|---|---|---|---|---|---|---|---|---|---|---|---|---|---|---|
| | | Fine | | | | | Dimension (mm) | | | Weight | Temp. | Time | Pres. | Strength | Density |
| No | IBA | IBA | WG | G | Water | WCO | L | W | H | (g) | (° C.) | (h) | (MPa) | (MPa) | (g/cm³) |
| 28 | 100 | 0 | 18 | 16.2 | 0 | 0 | 100 | 100 | 54.18 | 883 | 160 | 48 | 4 | 7.1 | 1.672 |
| 29 | 100 | 0 | 18 | 16.2 | 0 | 0 | 100 | 100 | 54.23 | 879 | 160 | 72 | 4 | 7.4 | 1.662 |
| 30 | 100 | 0 | 18 | 16.2 | 0 | 0 | 100 | 100 | 53.85 | 876 | 160 | 96 | 4 | 7.2 | 1.668 |
| 31 | 100 | 0 | 14 | 12.6 | 0 | 0 | 100 | 100 | 53.32 | 908 | 160 | 24 | 8 | 8.65 | 1.747 |
| 31a | 100 | 0 | 14 | 12.6 | 0 | 0 | 100 | 100 | 52.96 | 897 | 160 | 24 | 12 | 13.6 | 1.737 |
| 31b | 100 | 0 | 14 | 12.6 | 0 | 0 | 100 | 100 | 51.73 | 902 | 160 | 24 | 16 | 15.5 | 1.788 |
| 31c | 100 | 0 | 14 | 12.6 | 0 | 0 | 100 | 100 | 51.3 | 900 | 160 | 24 | 20 | 18.8 | 1.799 |
| 32 | 100 | 0 | 10 | 9 | 0 | 10 | 100 | 100 | 53.2 | 931.5 | 160 | 24 | 4 | 4.25 | 1.796 |
| 33 | 100 | 0 | 10 | 9 | 0 | 10 | 100 | 100 | 53.06 | 922 | 160 | 48 | 4 | 5.95 | 1.782 |
| 34 | 100 | 0 | 10 | 9 | 0 | 10 | 100 | 100 | 53.66 | 914.5 | 160 | 72 | 4 | 9.8 | 1.748 |
| 35 | 100 | 0 | 5 | 4.5 | 0 | 10 | 100 | 100 | 56.42 | 947.5 | 160 | 24 | 4 | 6.9 | 1.722 |
| 36 | 100 | 0 | 5 | 4.5 | 0 | 10 | 100 | 100 | 56.21 | 941.5 | 160 | 48 | 4 | 13.65 | 1.718 |
| 37 | 100 | 0 | 5 | 4.5 | 0 | 10 | 100 | 100 | 56.61 | 937.5 | 160 | 72 | 4 | 12.75 | 1.699 |
| 38 | 100 | 0 | 7 | 6.3 | 0 | 10 | 100 | 100 | 55.65 | 941 | 160 | 24 | 4 | 4.1 | 1.734 |
| 39 | 100 | 0 | 7 | 6.3 | 0 | 10 | 100 | 100 | 54.81 | 931 | 160 | 48 | 4 | 10.1 | 1.742 |
| 40 | 100 | 0 | 15 | 13.5 | 0 | 5 | 100 | 100 | 53.95 | 896 | 160 | 48 | 4 | 9.2 | 1.703 |
| 41 | 100 | 0 | 15 | 13.5 | 0 | 5 | 100 | 100 | 53.59 | 885.5 | 160 | 72 | 4 | 10.75 | 1.695 |
| 42 | 100 | 0 | 15 | 13.5 | 0 | 5 | 100 | 100 | 54.02 | 890.5 | 160 | 96 | 4 | 10.4 | 1.691 |
| 43 | 80 | 20 | 5 | 4.5 | 0 | 10 | 100 | 100 | 55.11 | 948 | 160 | 24 | 4 | 10.5 | 1.764 |
| 44 | 80 | 20 | 5 | 4.5 | 0 | 10 | 100 | 100 | 55.45 | 948 | 160 | 48 | 4 | 14.35 | 1.753 |
| 45 | 80 | 20 | 5 | 4.5 | 0 | 10 | 100 | 100 | 55.75 | 939 | 160 | 72 | 4 | 14.2 | 1.727 |
| 46 | 80 | 20 | 7 | 6.3 | 0 | 10 | 100 | 100 | 55.55 | 950 | 160 | 24 | 4 | 5.9 | 1.754 |
| 47 | 80 | 20 | 7 | 6.3 | 0 | 10 | 100 | 100 | 55.36 | 937.5 | 160 | 48 | 4 | 13.4 | 1.737 |
| 48 | 80 | 20 | 7 | 6.3 | 0 | 10 | 100 | 100 | 54.9 | 936 | 160 | 72 | 4 | 13.1 | 1.749 |

TABLE 4

| | Material Composition (wt %) | | | | | | | | | | Curing | Curing | Comp | | |
|---|---|---|---|---|---|---|---|---|---|---|---|---|---|---|---|
| | | Fine | | | | | Dimension (mm) | | | Weight | Temp. | Time | Pres. | Strength | Density |
| No | IBA | IBA | WG | G | Water | WCO | L | W | H | (g) | (° C.) | (h) | (MPa) | (MPa) | (g/cm³) |
| 48 | 80 | 20 | 7 | 6.3 | 0 | 10 | 100 | 100 | 54.9 | 936 | 160 | 72 | 4 | 13.1 | 1.749 |
| 49 | 80 | 20 | 5 | 4.5 | 0 | 10 | 100 | 100 | 55.66 | 938 | 160 | 40 | 4 | 12 | 1.728 |
| 50 | 80 | 20 | 5 | 4.5 | 0 | 10 | 100 | 100 | 56.38 | 951.5 | 160 | 48 | 4 | 12.6 | 1.731 |
| 55 | 80 | 20 | 10 | 9 | 0 | 7 | 100 | 100 | 55.28 | 914.5 | 160 | 48 | 4 | 9.2 | 1.697 |
| 56 | 80 | 20 | 10 | 9 | 0 | 7 | 100 | 100 | 55.02 | 928.5 | 160 | 48 | 4 | 9.25 | 1.731 |
| 57 | 80 | 20 | 10 | 9 | 0 | 7 | 100 | 100 | 54.75 | 920 | 160 | 72 | 4 | 8.75 | 1.723 |
| 58 | 80 | 20 | 10 | 9 | 0 | 10 | 100 | 100 | 61.91 | 903.5 | 160 | 48 | 4 | 5.6 | 1.497 |
| 59 | 80 | 20 | 10 | 9 | 0 | 10 | 100 | 100 | 62.12 | 898 | 160 | 48 | 4 | 5.8 | 1.483 |
| 60 | 80 | 20 | 10 | 9 | 0 | 10 | 100 | 100 | 55.29 | 904.5 | 160 | 48 | 16 | 14.5 | 1.678 |
| 61 | 80 | 20 | 15 | 13.5 | 0 | 5 | 100 | 100 | 53.82 | 892 | 160 | 48 | 4 | 11 | 1.7 |
| 62 | 80 | 20 | 15 | 13.5 | 0 | 5 | 100 | 100 | 53.39 | 902 | 160 | 48 | 4 | 12 | 1.733 |
| 62a | 80 | 20 | 15 | 13.5 | 0 | 5 | 100 | 100 | 53.12 | 906 | 160 | 48 | 4 | 11.5 | 1.749 |
| 62b | 80 | 20 | 15 | 13.5 | 0 | 5 | 100 | 100 | 53.65 | 896 | 160 | 48 | 4 | 11.55 | 1.713 |
| 62c | 80 | 20 | 15 | 13.5 | 0 | 5 | 100 | 100 | 53.08 | 906.5 | 160 | 48 | 4 | 9.6 | 10.88333 |
| 62d | 80 | 20 | 15 | 13.5 | 0 | 5 | 100 | 100 | 62.93 | 1078 | 160 | 48 | 4 | 10.1 | 1.757 |
| 62e | 80 | 20 | 15 | 13.5 | 0 | 5 | 100 | 100 | 62.56 | 1079.5 | 160 | 48 | 4 | 9.6 | 1.77 |
| 62f | 80 | 20 | 15 | 13.5 | 0 | 5 | 100 | 100 | 62.26 | 1079 | 160 | 48 | 4 | 8.7 | 9.466667 |
| 62g | 80 | 20 | 15 | 13.5 | 0 | 5 | 100 | 100 | 62.39 | 1080 | 160 | 48 | 4 | 10.7 | 1.775 |
| 62h | 80 | 20 | 15 | 13.5 | 0 | 5 | 100 | 100 | 62.51 | 1080.5 | 160 | 48 | 4 | 9.7 | 1.773 |
| 62i | 80 | 20 | 15 | 13.5 | 0 | 5 | 100 | 100 | 53.14 | 899.5 | 160 | 48 | 4 | 11.35 | 10.58333 |
| 62j | 80 | 20 | 15 | 13.5 | 0 | 5 | 100 | 100 | 57.15 | 896 | 160 | 48 | 1 | 6.3 | 1.608 |
| 62k | 80 | 20 | 15 | 13.5 | 0 | 5 | 100 | 100 | 53.5 | 893 | 160 | 48 | 2 | 10.1 | 1.712 |
| 62l | 80 | 20 | 15 | 13.5 | 0 | 5 | 100 | 100 | 52.1 | 895 | 160 | 48 | 4 | 12.8 | 1.762 |
| 62m | 80 | 20 | 15 | 13.5 | 0 | 5 | 100 | 100 | 50.32 | 893.5 | 160 | 48 | 8 | 16.6 | 1.821 |

TABLE 5

| | Material Composition (wt %) | | | | | | | | | | Curing | Curing | Comp | | |
|---|---|---|---|---|---|---|---|---|---|---|---|---|---|---|---|
| | | Fine | | | | | Dimension (mm) | | | Weight | Temp. | Time | Pres. | Strength | Density |
| No | IBA | IBA | WG | G | Water | WCO | L | W | H | (g) | (° C.) | (h) | (MPa) | (MPa) | (g/cm³) |
| 63 | 80 | 20 | 10 | 9 | 0 | 3.3 | 100 | 100 | 52.1 | 914 | 160 | 48 | 12 | 14.3 | 1.799 |
| 64 | 80 | 20 | 10 | 9 | 0 | 3.3 | 100 | 100 | 51.13 | 918 | 160 | 48 | 16 | 18.1 | 1.841 |
| 65 | 80 | 20 | 10 | 9 | 0 | 3.3 | 100 | 100 | 50.46 | 917 | 160 | 48 | 20 | 19.7 | 1.864 |

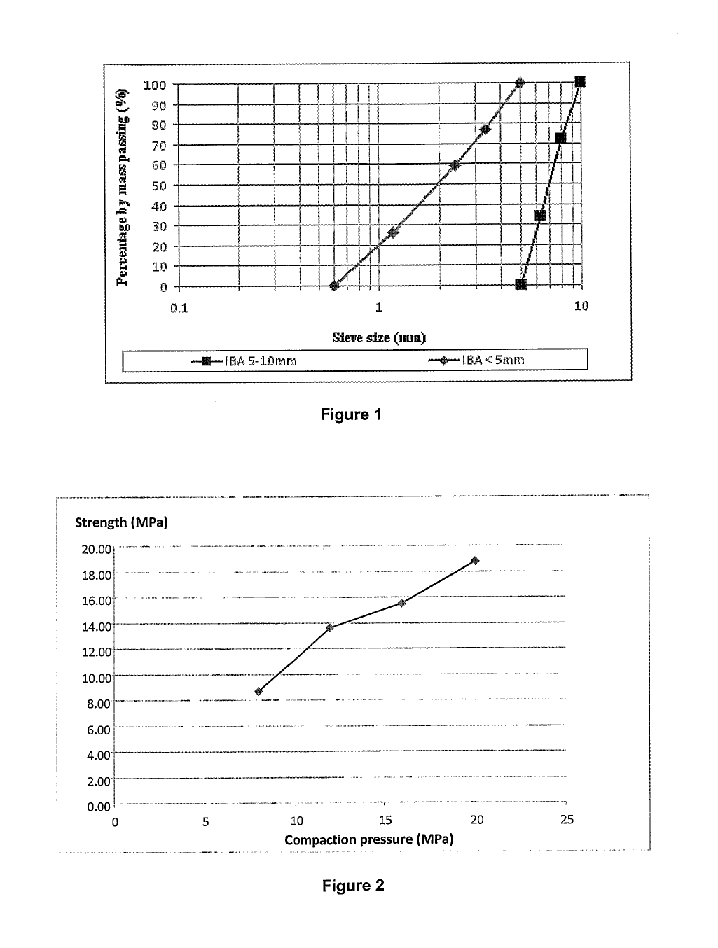

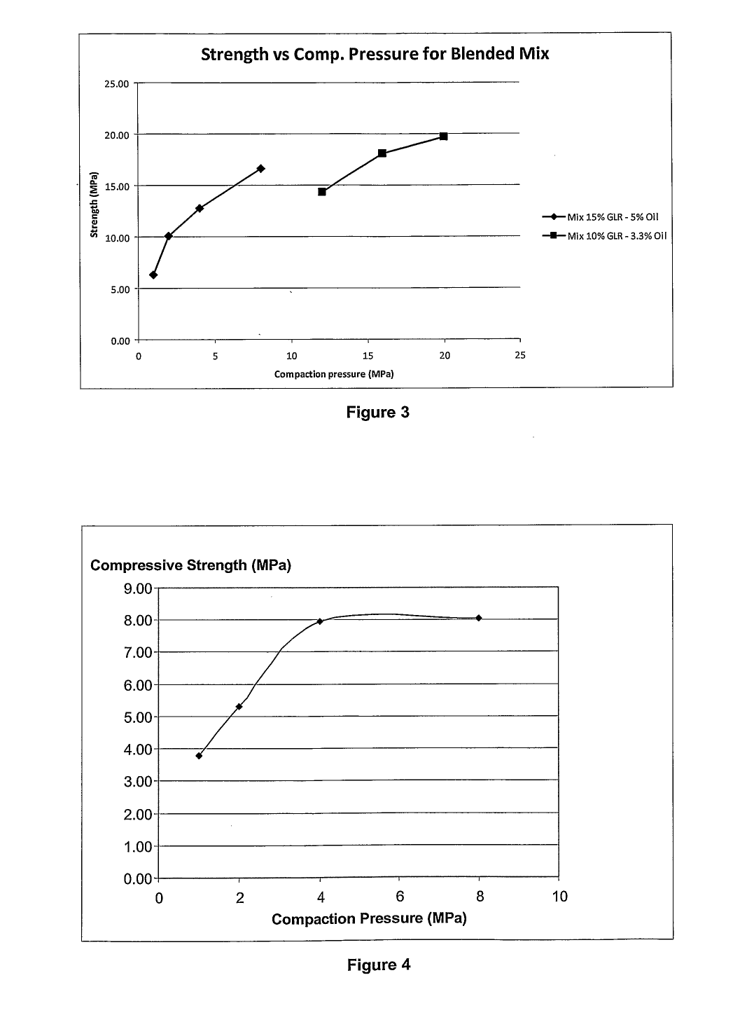

FIG. 2 shows the relationship between compressive strength and compaction pressure for samples 31 to 31c, which incorporate a binder comprised of 14 wt % waste glycerol and no vegetable oil. This binder therefore contains 12.6 wt % glycerol since 1.4 wt % of the binder is water. As can be seen from FIG. 2 the construction elements exhibit the expected relationship of increasing strength with increasing compaction pressure. FIG. 3 shows a similar relationship between strength and compaction pressure for two further samples according to the present invention, this time containing binders with 15 wt % waste glycerol and 5 wt % vegetable oil (samples 62j to 62m), and 10 wt % waste glycerol and 3.3 wt % vegetable oil (samples 63 to 65). A comparison of the results shown in FIG. 2 to those shown in FIG. 3 suggests that the strength of the construction units can be increased by adding a relatively small amount of vegetable oil—compare, for example, the strength exhibited by sample 31c (14 wt % waste glycerol and 0 wt % vegetable oil; 15.5 MPa at 16 MPa compaction) to that of sample 62m (15 wt % waste glycerol and 5 wt % vegetable oil; 16.6 MPa at 8 MPa compaction) and sample 64 (10 wt % waste glycerol and 3.3 wt % vegetable oil; 18.1 MPa at 16 MPa compaction).

FIG. 4 illustrates how compressive strength varies with compaction pressure for a series of samples according to the present invention incorporating 22 wt % waste glycerol binder (samples 12 to 15; equivalent to a binder containing 19.8 wt % pure glycerol). As can be seen, for compositions of this kind the optimum compaction pressure seems to be around 4 MPa since higher pressures have little or no effect on the ultimate strength of the sample.

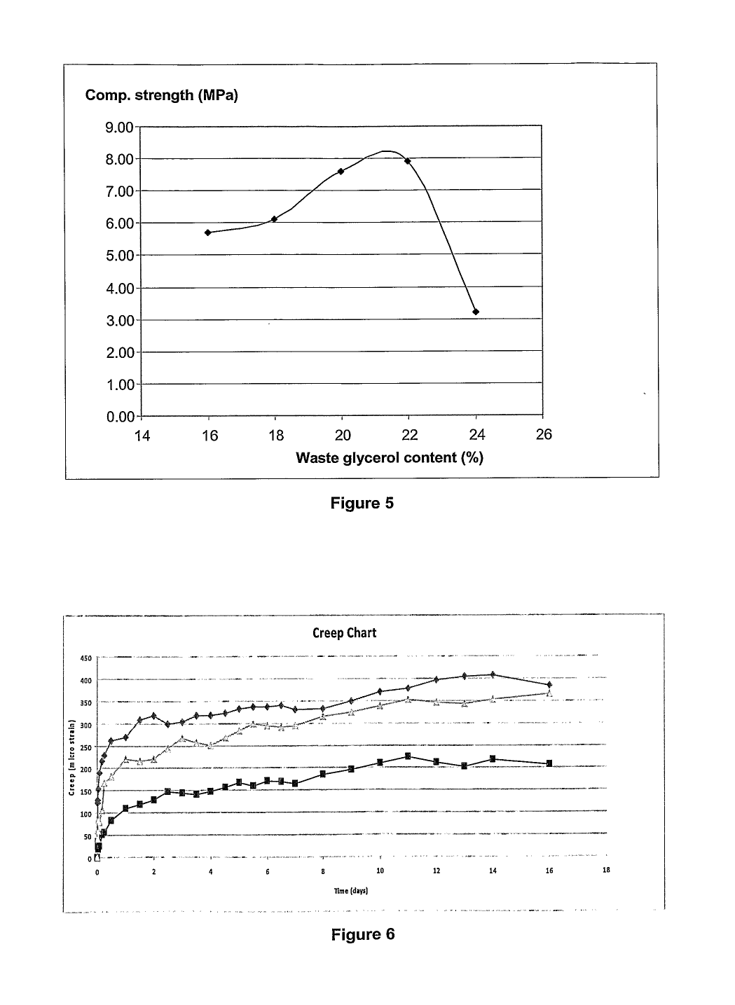

FIG. 5 shows how compressive strength varies with waste glycerol content for a series of samples according to the present invention incorporating 16 to 22 wt % waste glycerol binder (samples 1 to 4; equivalent to 14.4 to 19.8 wt % pure glycerol) and a further sample not in accordance with the present invention incorporating 24 wt % waste glycerol binder (sample 5; equivalent to 21.6 wt % pure glycerol). These results clearly illustrate the negative effect of including too much glycerol binder in the composition. At 4 MPa compaction pressure the samples containing 16, 18, 20 and 22 wt % waste glycerol (14.4 to 19.8 wt % pure glycerol) exhibit increasing strength with increasing binder content until the total binder content exceeds 20 wt % when the sample containing 24 wt % waste glycerol (21.6 wt % pure glycerol) is significantly weaker.

Creep/Shrinkage

Creep is defined by subtracting the elastic strain and shrinkage from the total strain measured on a loaded sample. The shrinkage must be recorded on an identical sample to the one under load. This identical sample must also be stored in the same environment as the loaded sample. In the present case, an unloaded sample expands. Therefore, creep is defined by subtracting the elastic strain and ADDING the expansion to the total strain.

Two sets of experiments were carried out, each using three samples incorporating a graded IBS aggregate and a binder containing 15 wt % waste glycerol (equivalent to 13.5 wt % pure glycerol) and 5 wt % vegetable oil. The mixes were cured at 160° C. for 48 hours and then compacted at 4 MPa pressure.

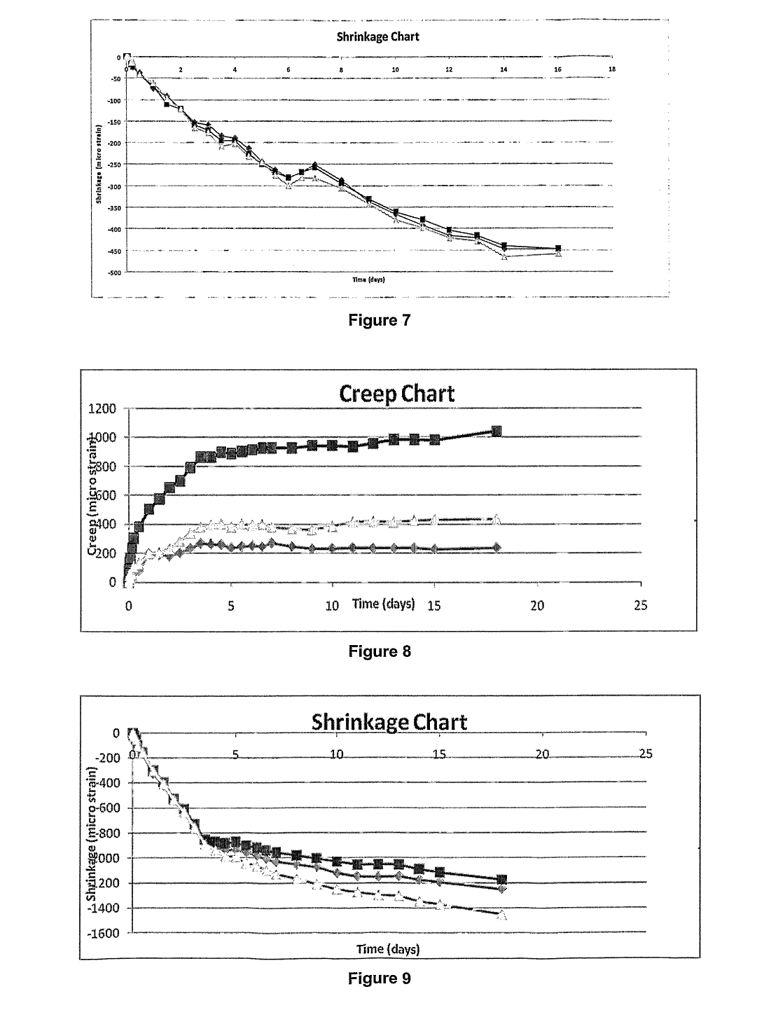

The results obtained for the first three samples are shown in FIGS. 6 and 7. The samples were loaded at an age of 5 days and so Day 0 of the Creep graph (FIG. 6) is actually when the samples are loaded, i.e. when 5 days old. With respect to the Shrinkage graph (FIG. 7), Day 0 is also effectively Day 5 (i.e. the expansion that has occurred prior to the time the creep tests start is not shown).

The results obtained for the second three samples are shown in FIGS. 8 and 9. The samples were loaded at an age of 1 day and so Day 0 of the Creep graph (FIG. 8) is actually when the samples are loaded, i.e. when 1 day old. With respect to the Shrinkage graph (FIG. 9), Day 0 is also effectively Day 1 (i.e. the expansion that has occurred prior to the time the creep tests start is not shown). This difference in Day 0 in respect of the first and second sets of samples explains why the levels of creep and expansion from Day 0 to Day 4 in the second set are so much greater than for the first set.

The creep and shrinkage (expansion data) behaviour shown in FIGS. 6 to 9 suggest that for samples compacted at 4 MPa and cured for 48 hours at 160° C., if they are loaded at an age of 14 days and over, creep should not be greater than 200 microstrains, and may not be greater than around 100 microstrain, and the expansion should not be greater than 200 microstrains. With respect to the expansion, the samples are dimensionally stable (at constant temperature and relative humidity) after 3 weeks and are better than current cement/clay products which exhibit creep and shrinkage/expansion of potentially 100 microstrains.

Overall this data suggests that it may be advisable to wait for around 14 to 21 days before using the construction elements according to the present invention. That being said, the results for the second set show that after Day 13 (when the samples are 14 days old) there is very little expansion and therefore very little corresponding creep. As such, these data suggest that the 14 day threshold before use may be realistic in practice.

Water Absorption

Water absorption of samples according to the present invention was tested using standard methods. The results obtained are presented below in Table 6. As can be seen, all samples exhibited acceptable water absorption.

Initial Rate of Suction

The initial rate of suction (IRS) of samples according to the present invention was tested using standard methods. The results obtained are presented below in Table 7. As can be seen, all samples exhibited acceptable IRS values.

TABLE 6

| | | | | | | | | Hot | | Comp. | | | | | | |
|---|---|---|---|---|---|---|---|---|---|---|---|---|---|---|---|---|
| Material Composition (wt %) | | | | | | | | Dry | Wet | Test | Curing | Curing | Comp. | Comp. | Water | |
| | Fine | | | | Dimension (mm) | | | weight | weight | weight | Temp. | Time | Pres. | Strength | Absorption | Density |
| IBA | IBA | WG | Water | WCO | L | W | H | (g) | (g) | (g) | (° C.) | (h) | (MPa) | (MPa) | (%) | (g/cm3) |
| 80 | 20 | 15 | 0 | 5 | 100 | 100 | 62.94 | 1063 | 1170 | 1081 | 160 | 48 | 4 | 9.7 | 10.07 | 1.762 |
| 80 | 20 | 15 | 0 | 5 | 100 | 100 | 62.73 | 1061.5 | 1175 | 1079 | 160 | 48 | 4 | 9.4 | 10.69 | 1.764 |
| 80 | 20 | 15 | 0 | 5 | 100 | 100 | 62.57 | 1062 | 1159 | 1080 | 160 | 48 | 4 | 10 | 9.13 | 1.77 |
| 80 | 20 | 15 | 0 | 5 | 100 | 100 | 62.84 | 1060.5 | 1194 | 1067.5 | 160 | 48 | 4 | 9.1 | 12.59 | 1.742 |
| 80 | 20 | 15 | 0 | 5 | 100 | 100 | 62.23 | 1064.5 | 1189 | 1071.5 | 160 | 48 | 4 | 10.9 | 11.7 | 1.766 |
| 80 | 20 | 15 | 0 | 5 | 100 | 100 | 62.5 | 1058 | 1192.5 | 1065 | 160 | 48 | 4 | 11.2 | 12.71 | 1.748 |
| 80 | 20 | 15 | 0 | 5 | 100 | 100 | 53.56 | 876.5 | 995 | 883 | 160 | 48 | 4 | 12 | 13.52 | 1.691 |
| 80 | 20 | 15 | 0 | 5 | 100 | 100 | 53.1 | 878 | 992.5 | 885 | 160 | 48 | 4 | 12.3 | 13.04 | 1.709 |
| 80 | 20 | 15 | 0 | 5 | 100 | 100 | 53.55 | 879.5 | 992.5 | 886 | 160 | 48 | 4 | 11.3 | 12.85 | 1.697 |

TABLE 7

| Material Composition (wt %) | | | | | | | | Dry | Wet | Curing | Curing | Comp. | IRS |
|---|---|---|---|---|---|---|---|---|---|---|---|---|---|
| | Fine | | | | Dimension (mm) | | | weight | weight | Temp. | Time | Pressure | (kg/m2 · |
| IBA | IBA | WG | Water | WCO | L | W | H | (g) | (g) | (° C.) | (h) | (MPa) | min) |
| 80 | 20 | 15 | 0 | 5 | 100 | 100 | | 1070 | 1073 | 160 | 48 | 4 | 0.25 |
| 80 | 20 | 15 | 0 | 5 | 100 | 100 | | 1075 | 1077 | 160 | 48 | 4 | 0.15 |
| 80 | 20 | 15 | 0 | 5 | 100 | 100 | | 1066 | 1069 | 160 | 48 | 4 | 0.25 |

### Comparative Example

A series of blocks containing furnace bottom ash (FBA) and pulverised fuel ash (PFA) of different composition were constructed to investigate the viability of producing construction materials containing glycerol or an alkaline activator. The compositions of the blocks are shown below in Table 10.

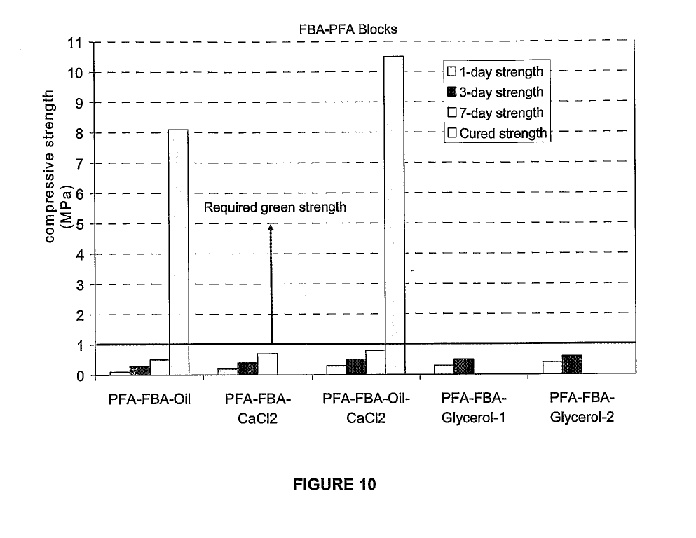

The compressive strength (in MPa) of each block after 1, 3 and 7 days was determined, as was the compressive strength of each block 1 day after curing. The results of these tests are shown in Table 8 and FIG. 10.

TABLE 8

| | FBA | FBA | | | | | | | | 1-day |
|---|---|---|---|---|---|---|---|---|---|---|
| PFA | (course) | (Fines) | Oil | CaCl₂ | Glycerol | | 1-day | 3-day | 7-day | cured |
| (%) | (%) | (%) | (%-mix) | (%-mix) | (%-mix) | Water | strength | strength | strength | strength |
| 30 | 30 | 40 | 12 | | | 10% | 0.1 | 0.3 | 0.5 | 8.1 |
| 30 | 30 | 40 | | 2 | | 20% | 0.2 | 0.4 | 0.6 | — |
| 30 | 30 | 40 | 12 | 2 | | 10% | 0.3 | 0.5 | 0.7 | 10.5 |
| 30 | 30 | 40 | | | 5 | 15% | 0.3 | 0.5 | | |
| 30 | 30 | 40 | | | 10 | 15% | 0.4 | 0.6 | | |

Approximate required green strength (i.e. virgin strength or pre-curing strength) in order to physically move the block to enable it to be appropriately arranged to be cured is about 1 MPa.

The samples containing the alkaline activator (CaCl₂) and vegetable oil, and the samples containing just glycerol at 5% and 10% did not give the required strength (1 MPa), even 7 days after sample preparation. However, the samples with only oil and oil with CaCl₂ (oven cured at 160° C. for 24 hours) gave the required strengths for standard blocks.

1.-56. (canceled)

57. A composition for use in the production of a construction element, said composition comprising:
an aggregate; and
a glycerol-containing binder, wherein the total binder content of the composition is greater than around 10 wt % and less than or equal to around 20 wt %.

58. The composition according to claim 57, wherein the glycerol content of the composition is about 1 to about 20 wt %.

59. The composition according to claim 57, further comprising vegetable oil, wherein vegetable oil content of the composition is about 1 to about 15 wt %.

60. The composition according to claim 57, wherein the total binder content of the composition is around 12 to 18 wt %.

61. The composition according to claim 57, wherein said aggregate is graded and has a maximum aggregate particle size of around 15 mm.

62. The composition according to claim 57, wherein said aggregate has an aggregate porosity selected from the group consisting of:
greater than around 5%,
less than around 50%, and
greater than around 5% and less than around 50%.

63. A construction element comprising:
an aggregate;
a glycerol-containing binder; and
vegetable oil,
wherein the vegetable oil content of the composition is about 1 to about 15 wt %,
wherein said vegetable oil is at least partially cured, and
wherein the total binder content of the composition is greater than around 10 wt % and less than or equal to around 20 wt %.

64. The construction element according to claim 63, wherein said construction element is a structural element.

65. The construction element according to claim 63, further comprising a reinforcement selected from the group consisting of:
internal reinforcement,
internal reinforcement including a fibrous reinforcing agent, and
external reinforcement.

66. A structural element comprising:
an aggregate;
glycerol; and
at least partially cured vegetable oil.

67. The structural element according to claim 66, wherein said aggregate is graded and has properties selected from the group consisting of:
a maximum aggregate particles size of around 15 mm,
an aggregate porosity of greater than 5%, and
a maximum aggregate particles size of around 15 mm and an aggregate porosity of greater than 5%.

68. The structural element according to claim 66, further comprising a reinforcement selected from the group consisting of:
internal reinforcement,
internal reinforcement including a fibrous reinforcing agent, and
external reinforcement.

69. A method for producing a construction element comprising:
mixing a glycerol-containing binder with an aggregate to form a mixture; and
forming the mixture into said construction element,
wherein the total binder content of the mixture is greater than around 10 wt % and less than or equal to around 20 wt %.

70. The method according to claim 69, wherein the glycerol content of the mixture is about 1 to about 20 wt %.

71. The method according to claim 69, wherein said mixing of the glycerol-containing binder and aggregate is effected in the presence of an aqueous medium.

72. The method according to claim 69, wherein the method further comprises mixing vegetable oil with said glycerol-containing binder and aggregate.

73. The method according to claim 69, further comprising heating the mixture of glycerol-containing binder and aggregate.

74. The method according to claim 73, wherein heating the mixture includes one of heating the mixture up to around 200° C., heating the mixture to at least 50° C., and heating the mixture up to around 200° C. and at least 50° C.

75. The method according to claim 73, wherein heating the mixture includes heating the mixture over a time period selected from the group consisting of:
up to around 48 hours,
at least around 2 hours,
around 24 hours to around 40 hours, and
around 36 hours.

76. The method according to claim 73, wherein forming the mixture into said construction element further includes subjecting the mixture containing glycerol and aggregate to a compaction level selected from the group consisting of:
around 1 to around 20 MPa,
around 2 to around 16 MPa, and
around 4 to around 12 MPa.

77. The method according to claim 76, further comprising compacting the mixture at a stage selected from the group consisting of:
before heating the mixture, and
and during heating the mixture.

78. A construction element produced by a method comprising:
mixing a glycerol-containing binder with an aggregate to form a mixture; and
forming the mixture into said construction element,
wherein the total binder content of the mixture is greater than around 10 wt % and less than or equal to around 20 wt %.

79. The construction element according to claim 78, wherein said construction element is a structural element.
